(19) United States
(12) Patent Application Publication
(10) Pub. No.: US 2006/0263520 A1
(43) Pub. Date: Nov. 23, 2006

(54) Method for improving high-viscosity thick film photoresist coating in UV LIGA process

(76) Inventors: Der-Ren Kang, Taoyuan (TW); Chih-Chun Chan, Taoyuan (TW); Ker-Jer Huang, Taoyuan (TW); Soon-Lin Chen, Taoyuan (TW); Hsien-Ming Wu, Taoyuan (TW)

Correspondence Address: J C PATENTS, INC., 4 VENTURE, SUITE 250, IRVINE, CA, 92618, US

(21) Appl. No.: 11/135,841

(22) Filed: May 23, 2005

(51) Int. Cl. B05D 3/12; B05D 1/36; B05D 3/02

(52) U.S. Cl. 427/240; 427/402; 427/372.2

(57) ABSTRACT

A method for improving high-viscosity thick film photoresist coating in UV LIGA process is provided. Two photoresists of identical material but different solvent amount are coated on a silicon wafer in different ways to improve film thickness and flatness. The thick film photoresist SU8-2035 and SU8-2100 from MicroChem Corp. have a viscosity of 7000 (cSt) and 45000 (cSt), respectively. First, SU8-2035 is coated on the wafer at a constant speed, then SU8-2100 is coated from an edge to a center of the wafer in a spiral way, while the mass is measured to control the thickness of photoresist. In the soft baking step, the photoresist and wafer are heated on a hot plate. When the temperature rises over the glass transition temperature of the photoresist, the photoresist spreads on the wafer uniformly due to lower viscosity, cohesion and surface tension, while the wafer is rotated to improve the flatness of the photoresist.

### BACKGROUND OF THE INVENTION

1. Field of Invention

The present invention relates to a method that can effectively control the thickness and flatness of the high-viscosity thick film photoresist coating in a UV LIGA process.

2. Description of Related Art

Coating is an important step in a semiconductor process and micro-electronic process. In a conventional coating process, the silicon wafer is placed in the center of the rotating plate, then the spin coater starts rotating after the photoresist is distributed in the center of the silicon wafer, so that the photoresist can be coated on the silicon wafer by centrifugal force. The thickness is controlled by the rotation speed. Such coating method is suitable for low-viscosity photoresist. Different from the requirement of the UV LIGA process in a conventional integrated circuit, the UV LIGA process with high-viscosity thick film photoresist coating must be able to manufacture patterns with small line width, but also to manufacture the photoresist structure with a thickness of up to hundreds of micrometer. Therefore, the photoresist used in the manufacturing process usually is high-viscosity photoresist, such as SU8. However, the above spin coating method for the high-viscosity photoresist has such disadvantages as bubble, uneven thickness, edge bead and difficult thickness control. Accordingly, the present invention provides a method that can effectively control the thickness and flatness of the high-viscosity thick film photoresist to overcome the above disadvantages.

### SUMMARY OF THE INVENTION

According to the object stated above and other objects, the present invention is directed to a method for effectively controlling the thickness and flatness of the high viscosity thick film photoresist coating in a UV LIGA process. In the present invention, two thick film photoresist with identical material but different solution amount are overlapped. First, the low-viscosity photoresist is coated on the silicon wafer by spin-coating at a constant speed, then the high-viscosity photoresist is coated from the edge to the center of the wafer in a spiral method, while the mass is measured to control the thickness of photoresist. The coating step is followed by a soft baking step. The photoresist and wafer are heated on a hot plate in order to have the photoresist distribute on the wafer uniformly by the cohesion and surface tension of the photoresist, and also to control the photoresist thickness effectively.

Another object of the present invention is to rotate the hot plate in very low speed in the heating process on the hot plate, and to control the flatness of the photoresist by using the fluidity degression property of the photoresist along the soft baking time. Accordingly, the present invention can avoid the uneven hot plate in the conventional technology, and have the photoresist distribute evenly on the wafer to improve the flatness of the photoresist effectively. For example, a photoresist with a thickness of 500 μm can have an error of flatness down to ±10 μm.

### BRIEF DESCRIPTION OF THE DRAWINGS

FIG. 1 is a schematic block diagram of a conventional UV LIGA process.

FIG. 2 is a schematic block diagram of a coating process according to the present invention.

FIG. 3 is a schematic block diagram of a coating method according to the present invention.

FIG. 4 is a schematic block diagram of a soft baking method according to the present invention.

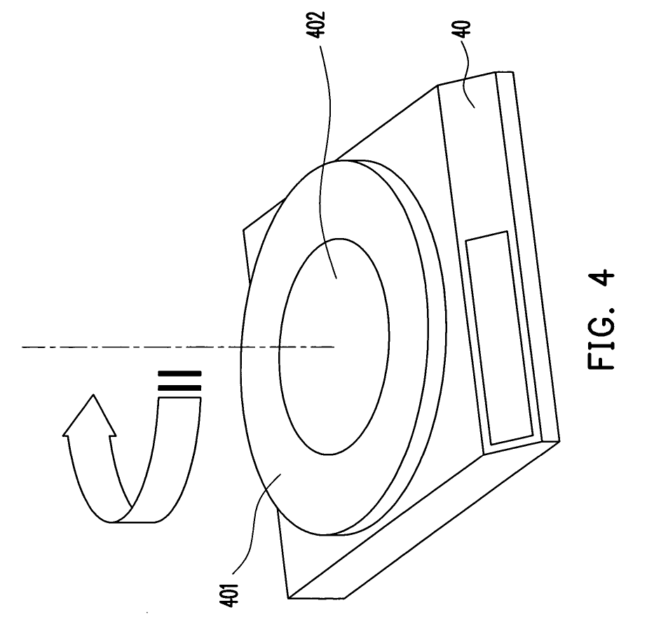

### DESCRIPTION OF EMBODIMENTS

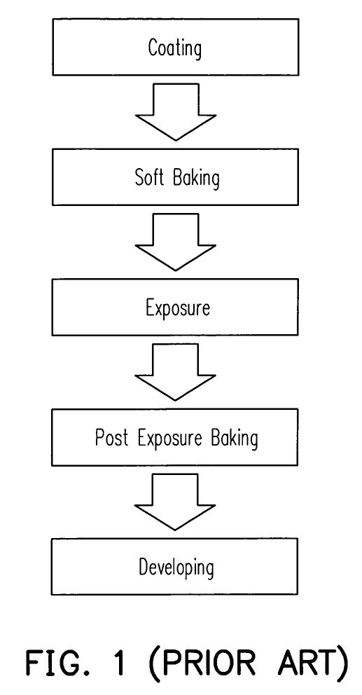

The UV LIGA technology is a method of manufacturing and defining a micro structure by exposing a UV light. The manufacturing process is as shown in FIG. 1. First, the photoresist is coated on a silicon wafer. Then the silicon wafer is soft baked on the hot plate. Next, after the solvent in the photoresist volatilizes to a certain extent, the wafer is exposed by 365 nm UV light. After the photoresist is exposed, post exposure bake is performed to accelerate the molecular bond reactivity. Then, a developing process is performed to remove the photoresist which did not absorb the UV light.

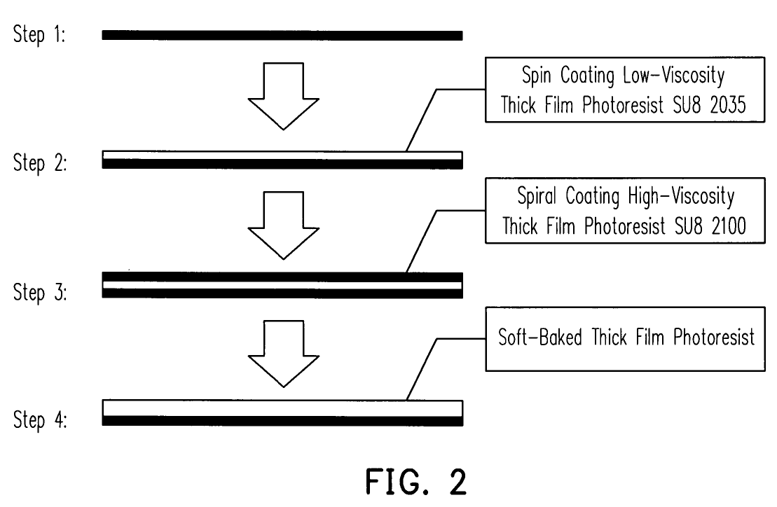

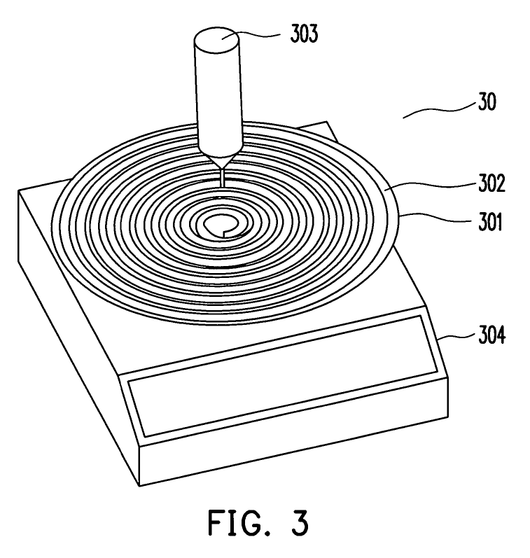

The present invention provides a method for improving high-viscosity thick film photoresist coating in UV LIGA process. Here, the thick film photoresist SU8 serial from MicroChem Corp. (MCC) is taken as the example shown in FIG. 2. Step 1, firstl, the silicon wafer is placed on the spinner; step 2, the low-viscosity thick film photoresist SU 8 2035 is coated on the wafer at a constant speed; step 3, as shown in FIG. 3, the silicon wafer 301 with the SU8 2035 coating is provided on the platform scale 304, and then the thick film photoresist SU 8 2100 302 is coated by the dot transfusing tube 303 in a spiral way from the edge to center of the wafer manually or by a dual axis mechanism, while the mass is measured by the platform scale 304 to control the thickness of the photoresist. When the weight reaches the predefined value, the dot transfusing tube 303 would stop providing the thick film photoresist SU8 2100 302.

After the step 3 of FIG. 2 is completed, as shown in FIG. 3, the coated photoresist and wafer 402 is heated on the rotatable heat tray 401 of the hot plate 40. When the temperature rises over the glass transition temperature (Tg) of the photoresist, the photoresist would spread on the wafer uniformly due to lower viscosity, cohesion and surface tension properties. In the soft baking process, the heat tray 401 is rotated with a fixed angle at specific time interval (such as 90°/15 min) so as to effectively control the uniform thickness of the photoresist when the solvent therein volatilizes and further improve the flatness of the photoresist.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for improving a coating process of high-viscosity thick film photoresist, comprising overlapping two thick film photoresists of identical material but different solvent amount; the method comprising:
coating one of the photoresists with a lower-viscosity on the silicon wafer at a constant rotating speed, and coating one of the photoresist with a higher-viscosity from an edge to a center of the wafer in a spiral way; and
measuring a mass to convert into a thickness of the photoresist simultaneously; and
rotating a heat tray by a fixed angle within a fixed time interval in a soft baking process.

2. The method as recited in claim 1, wherein the dot transfusing tube can be moved manually or by a dual axis mechanism.

3. The method as recited in claim 1, wherein when the mass measured by a platform scale reaches a predefined value, the platform scale sends a signal to the dot transfusing tube to stop providing the photoresist.

4. The method as recited in claim 1, wherein during the soft baking process, the heat tray can set with a control program for temperature and timing.

5. The method as recited in claim 1, wherein rotation of the heat tray can set by a manual way or an automatic way.
